(19) United States
(12) Patent Application Publication
(10) Pub. No.: US 2026/0158714 A1
(43) Pub. Date: Jun. 11, 2026

(54) METHOD AND MOLD FOR MANUFACTURING RESIN-MOLDED ARTICLE, AND RESIN-MOLDED ARTICLE

(71) Applicant: MORIROKU CO., LTD., Tokyo (JP)

(72) Inventors: Taiki Ito, Tokyo (JP); Tadashi Rokugawa, Tokyo (JP)

(21) Appl. No.: 19/182,146

(22) Filed: Apr. 17, 2025

(30) Foreign Application Priority Data
Apr. 25, 2024 (JP) 2024-071561

(51) Int. Cl. B29C 45/04; B29C 37/00; B29C 45/00; B29C 45/14; B29C 45/33; B29L 31/30

(52) U.S. Cl. CPC B29C 45/0416; B29C 45/14008; B29C 45/33; B29C 2037/0046; B29C 2045/0089; B29L 2031/3008

(57) ABSTRACT

A method for manufacturing a resin-molded article is performed through the following steps. A film is fixed to a first fixed mold such that a surface of the film to which ink is attached faces a movable mold. Next, a first cavity is formed using the movable mold and a slide mold by sliding the slide mold, and a second cavity is formed using the first fixed mold and the movable mold by aligning the movable mold with the first fixed mold to which the film is fixed. Next, molten resin is injected into the first cavity and the second cavity and is cured. In the cavity forming step, the ink faces only the second cavity.

### FIELD OF THE INVENTION

The present invention relates to a technique for manufacturing a resin-molded article.

### BACKGROUND

As illustrated in Japanese Unexamined Patent Publication No. 2011-011523, a mold includes a first fixed mold that is fixed; a first movable mold movable with respect to the first fixed mold and capable of sandwiching a film, to which ink is attached, therebetween; and a second movable mold movable with respect to the first fixed mold and capable of forming a cavity having a shape different from that of the first movable mold.

The first movable mold with the film sandwiched therebetween is aligned with the first fixed mold, and molten resin is injected into a first cavity thus formed and then is cured. The ink attached to the film is transferred onto the cured resin. The first movable mold is retreated in a state where the resin onto which the ink is transferred is left, and next, the second movable mold is overlaid on the resin to form a second cavity. A resin-molded article in which a printed portion is sandwiched between the resins can be obtained by injecting molten resin into the second cavity and curing the molten resin.

### SUMMARY

Among resin-molded articles, there is a resin-molded article including a first resin component including a portion onto which ink needs to be prevented from being transferred, and a second resin component of which at least a part needs to be subjected to printing. It is preferable that the resin-molded article having such a complex structure can be manufactured through a smaller number of steps.

According to one aspect of the present disclosure, there is provided a method for manufacturing a resin-molded article, the method including: a preparation step of preparing a first fixed mold that is immovable, a movable mold provided to be displaceable in one direction with respect to the first fixed mold, a slide mold provided to be slidable in a direction different from the one direction with respect to the movable mold, and a film to which ink to be transferred is attached; a film fixing step of fixing the film to the first fixed mold such that a surface of the film to which the ink is attached faces the movable mold; a first cavity forming step of forming a first cavity using the movable mold and the slide mold by sliding the slide mold, and forming a second cavity using the first fixed mold and the movable mold by aligning the movable mold with the first fixed mold to which the film is fixed; a first resin injecting step of injecting molten resin into the first cavity and the second cavity; and a first resin curing step of obtaining a first resin component cured in the first cavity and a second resin component cured in the second cavity by curing the resin injected into the first cavity and the second cavity. In the first cavity forming step, the ink faces only the second cavity.

In addition, according to another aspect of the present disclosure, there is provided a mold including: a first fixed mold that is immovable; a movable mold provided to be displaceable in one direction with respect to the first fixed mold; and a slide mold provided to be slidable in a direction different from the one direction with respect to the movable mold. The first fixed mold includes a placement portion on which a film to which ink is attached is placed. Resin is allowed to be injected between the movable mold and the slide mold by sliding the slide mold, and a first cavity that becomes a first resin component by curing the injected resin is formed. The resin is allowed to be injected into a portion, which the placement portion faces, by aligning the movable mold with the first fixed mold, and a second cavity that becomes a second resin component by curing the injected resin is formed.

In addition, according to yet another aspect of the present disclosure, there is provided a resin-molded article including: a first resin component that is resin component; a second resin component that is a resin component provided spaced apart from the first resin component; and a support component that integrally supports the first resin component and the second resin component. When a surface of the first resin component facing the support component is defined as a first support surface, and a surface of the second resin component facing the support component is defined as a second support surface, at least a part of the first support surface, resin constituting the first resin component is exposed to an outside, and at least a part of the second support surface is subjected to printing.

According to the present disclosure, a technique for manufacturing the resin-molded article that is manufactured through a small number of steps can be provided.

### BRIEF DESCRIPTION OF THE DRAWINGS

FIG. 1 is a front view of a resin-molded article according to an embodiment;

FIG. 2 is a cross-sectional view taken along line 2-2 in FIG. 1;

FIG. 3 is a view for describing printed regions of the resin-molded article illustrated in FIG. 1;

FIG. 4 is a view for describing a preparation step and a mold in a method for manufacturing the resin-molded article illustrated in FIG. 1;

FIG. 5 is a view for describing a second fixed mold;

FIG. 6 is a view for describing a film fixing step;

FIG. 7A is an enlarged view of a portion 7A of FIG. 6, and FIG. 7B is a view for describing a first cavity forming step;

FIG. 8A is a view for describing a first resin injecting step and a first resin curing step, and FIG. 8B is a view for describing a movable mold and slide mold raising step;

FIG. 9 is a view for describing a second cavity forming step;

FIG. 10A is an enlarged view of a portion 10A of FIG. 9, and FIG. 10B is a view for describing a second resin injecting step and a second resin curing step; and

FIG. 11A is a view for describing a slide mold retreat step, and FIG. 11B is a view for describing a mold opening step.

### DETAILED DESCRIPTION

An embodiment of the invention will be described below with reference to the accompanying drawings. In the description, left and right indicate left and right with reference to occupants of a vehicle, and front and rear indicate front and rear with reference to a traveling direction of the vehicle. A mode illustrated in the accompanying drawings is one example of the invention, and the invention is not limited to the mode.

### Embodiment

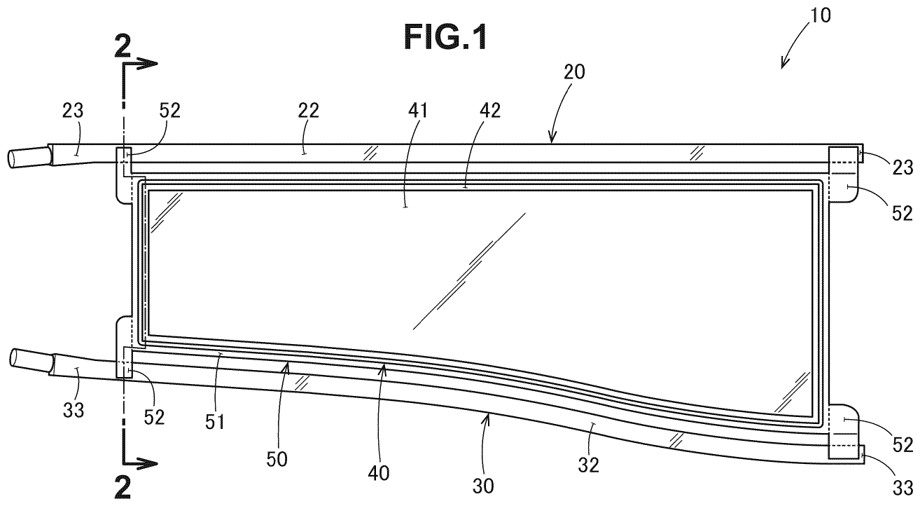

Referring to FIG. 1, a resin-molded article 10 is, for example, a decorative component provided in front of occupants of the vehicle and constituting a part of a dashboard.

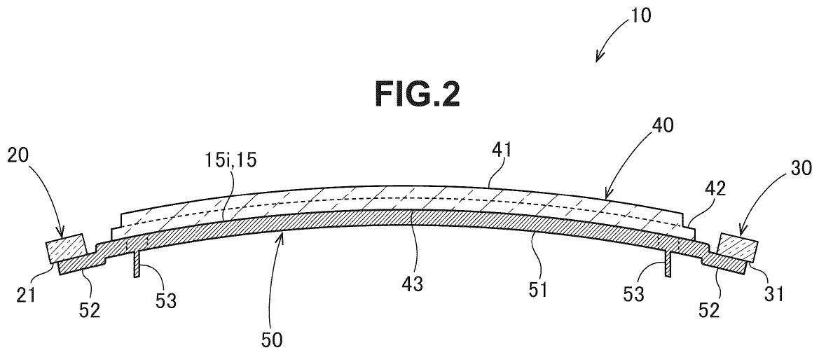

Referring to FIG. 2, the resin-molded article 10 includes two first resin components 20 and 30 which are made of transparent resin and through which light passes; a second resin component 40 made of transparent resin, provided between the first resin components 20 and 30 so as to be spaced apart therefrom, and irradiated with the light guided by the first resin components 20 and 30; and a support component 50 that is made of resin and that integrally supports the first resin components 20 and 30 and the second resin component 40.

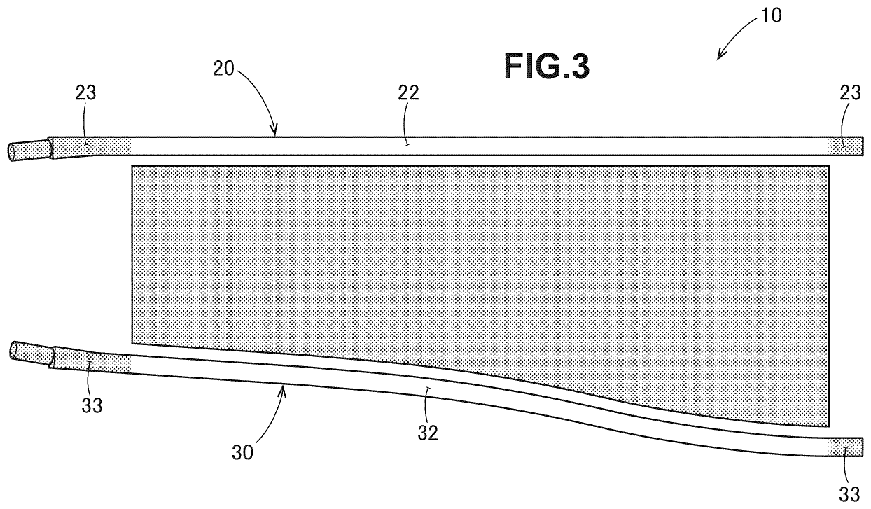

Referring to FIG. 3, ink 15i (refer to FIG. 2) is transferred onto parts of rear surfaces of the first resin components 20 and 30 and onto the entirety of a rear surface of the second resin component 40. In FIG. 3, regions onto which the ink 15i is transferred are illustrated by coloring.

Referring to FIG. 1, polycarbonate (PC) or acrylic resin (PMMA) can be used as the material of the first resin components 20 and 30. The same material is used for two first resin components 20 and 30. The first resin components 20 and 30 are provided along the longer sides of the second resin component 40.

At least one end (an end on the left side of the drawing in the present embodiment) of each of the first resin components 20 and 30 is connected to a light source such as an LED. Light emitted from the light source passes through the insides of the first resin components 20 and 30 that are light guides, is reflected toward the second resin component 40, and is incident on the second resin component 40.

Edges or the like for reflecting light toward the second resin component 40 may be formed in the first resin components 20 and 30. Accordingly, the entirety of the second resin component 40 can be more evenly irradiated.

One the first resin component 20 (the first resin component 20 on the upper side of the drawing) is substantially linearly formed. The other first resin component 30 (the first resin component 30 on the lower side of the drawing) has a shape that is partly gently curved. Each of the first resin components 20 and 30 has a shape extending along an outer edge of the second resin component 40.

The first resin components 20 and 30 may have the same shape. In addition, the number of the first resin components 20 and 30 may be one or three or more depending on the size or shape of the second resin component 40.

Referring to FIG. 2, hereinafter, the rear surfaces of the first resin components 20 and 30 may be referred to as first support surfaces 21 and 31 supported by the support component 50.

Referring to FIG. 3, portions onto which the ink 15i (refer to FIG. 2) is not transferred need to be formed at least parts of the first resin components 20 and 30. Namely, the first resin components 20 and 30 are components including portions onto which the ink 15i needs to be prevented from being transferred. In the first resin components 20 and 30, the portions onto which the ink 15i is not transferred are referred to as first resin component bodies 22 and 32, and the portions onto which the ink 15i is transferred are referred to as first resin component extension portions 23 and 33.

The first resin component bodies 22 and 32 are formed at portions between which the second resin component 40 is provided. Meanwhile, the first resin component extension portions 23 and 33 are formed at portions between which the second resin component 40 is not provided. The first resin component extension portions 23 and 33 extend from both ends of the first resin component bodies 22 and 32, respectively.

The first resin components 20 and 30 may be composed of only the first resin component bodies 22 and 32. In other words, the first resin components 20 and 30 may be formed only by the portions onto which the ink 15i is not transferred. By forming the portions, onto which the ink 15i is not transferred, at least parts of the first resin components 20 and 30, the absorption of the light incident on the first resin components 20 and 30 by the ink can be suppressed, and the light is allowed to bright illuminate up to a location farther from the light source.

Referring also to FIG. 2, at portions of the first support surfaces 21 and 31 onto which the ink 15i is not transferred, the resin constituting the first resin components 20 and 30 is exposed to the outside. The portions where the resin is exposed to the outside can also be referred to as portions that are not subjected to printing.

Referring to FIG. 1, polycarbonate (PC) or acrylic resin (PMMA) can be used as the material of the second resin component 40. The same material as the first resin components 20 and 30 is used as the material of the second resin component 40.

By providing the first resin components 20 and 30 and the second resin component 40, for which the same material is used, so as to be spaced apart from each other, a situation where the light is not sufficiently reflected and transmitted inside the first resin components 20 and 30 and immediately enters the second resin component 40 can be suppressed. Accordingly, loss of energy of the emitted light can be suppressed, and the second resin component 40 can be efficiently irradiated over a long distance far from the light source. The second resin component 40 is a substantially trapezoidal plate in which one side is gently curved. The shape of the second resin component 40 may be all sides linear, and may not be a substantially trapezoidal shape.

Referring to FIG. 2, the second resin component 40 is formed such that a thickness of an edge 42 that is the outer edge is thinner than a thickness of a general portion 41. The edge 42 is formed around the entirety of an outer periphery of the general portion 41.

When light is incident on the second resin component 40 from the first resin components 20 and 30, a pattern or the like formed by the ink 15i transferred onto the rear surface is illuminated, so that design is improved.

Hereinafter, the rear surface of the second resin component 40 may be referred to as a second support surface 43 supported by the support component 50.

Referring to FIG. 3, the entirety of the rear surface (the second support surface 43) of the second resin component 40 is subjected to printing.

A pattern or the like may be printed on the rear surface of the second resin component 40, and in this case, a part of the rear surface of the second resin component 40 may be exposed. In this respect, it can be said that a portion onto which the ink 15i (refer to FIG. 2) is transferred is formed at least a part of the rear surface of the second resin component 40.

Referring to FIG. 1, it is preferable that resin such as ABS resin is used as the material of the support component 50. It is preferable that a melting point of the ABS resin is lower than a melting point of the resin used as the material of the first resin components 20 and 30 and the second resin component 40. A colored resin that does not transmit light is used for the support component 50.

The support component 50 includes a frame 51 having a frame shape and provided along the rear surface of the edge 42 of the second resin component 40, and connecting portions 52 extending from the frame 51 toward the first resin components 20 and 30 and connecting the first resin components 20 and 30 and the second resin component 40. In addition, the connecting portions 52 are connected to portions of the first resin components 20 and 30 between which the second resin component 40 is not disposed. Namely, the connecting portions 52 extends to the first resin component extension portions 23 and 33.

Referring to FIG. 2, since the support component 50 is configured such that the connecting portions 52 are formed lower than the frame 51, the first resin components 20 and 30 are also located at a lower position than the second resin component 40. Accordingly, the light emitted from the first resin components 20 and 30 is incident mainly from the edge portion 42.

In the support component 50, ribs 53 extend from the rear surface of the frame 51 so as to be spaced apart from the second resin component 40. The resin-molded article 10 is attached to a vehicle body or the like via the ribs 53.

The resin-molded article 10 described above is formed by injection molding. A mold for forming the resin-molded article 10 and a method for manufacturing the resin-molded article 10 will be described.

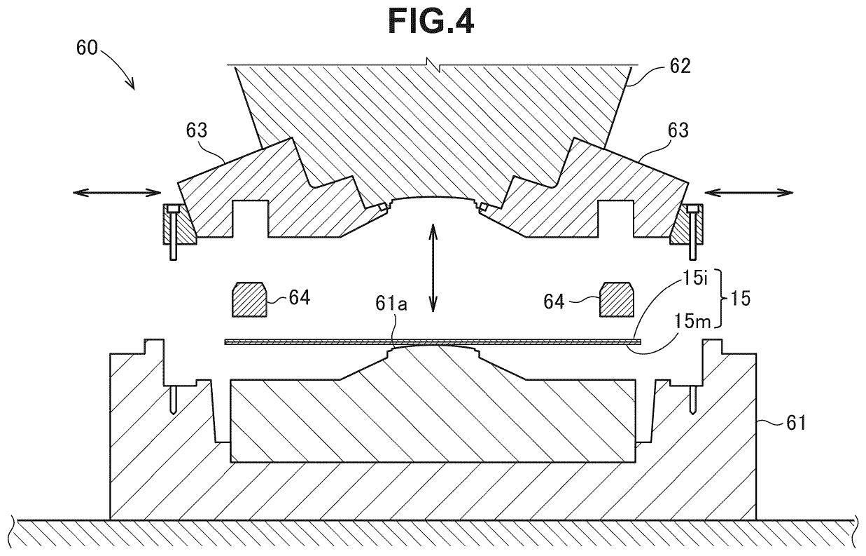

Referring to FIG. 4, first, a mold 60 will be described. The mold 60 includes a first fixed mold 61 that is an immovable mold; a movable mold 62 that is a mold that is raisable and lowerable (displaceable in one direction) with respect to the first fixed mold 61 and that is rotatable in a horizontal direction; a slide mold 63 that is a mold provided to be slidable with respect to the movable mold 62; and clamps 64 and 64 for pressing a film 15, to which the ink 15i is attached, onto the first fixed mold 61.

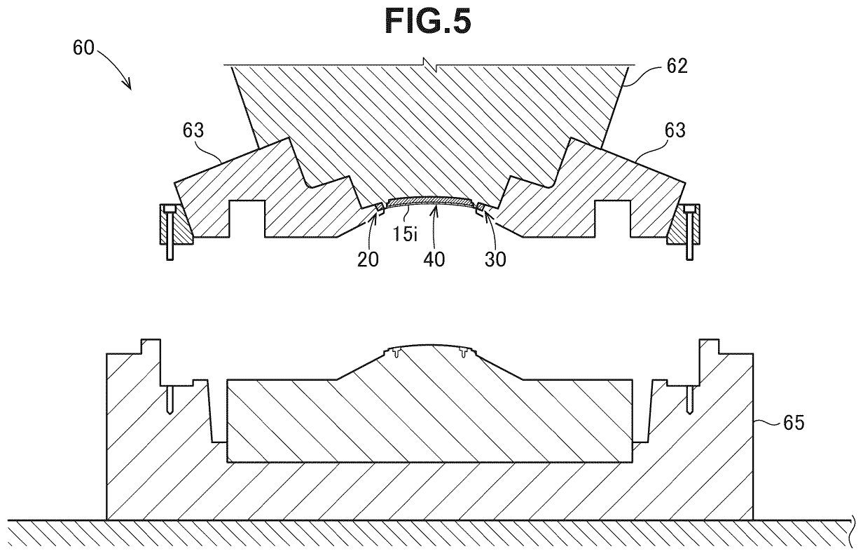

Referring to FIG. 5, the mold 60 further includes a second fixed mold 65 that is an immovable mold.

Referring to FIG. 4, the first fixed mold 61 includes a placement portion 61a on which the film 15 is placed. A hole for suctioning the film 15 onto the placement portion 61a may be formed in the first fixed mold 61.

Referring also to FIG. 5, for example, the movable mold 62 is rotated from above the first fixed mold 61 to move to above the second fixed mold 65. When the movable mold 62 is further rotated, the movable mold 62 returns to above the first fixed mold 61.

Two movable molds 62 may be provided. In this case, the slide molds 63 are also provided to match the respective movable molds 62. By providing the first fixed mold 61 and the second fixed mold 65 with 180° apart from each other and providing the two movable molds 62 (and the slide molds 63 corresponding to the respective movable molds 62) with 180° apart from each other, both the first fixed mold 61 and the second fixed mold 65 can be operated at the same time.

Three or more movable molds 62 (and the slide molds 63 corresponding to the respective movable molds 62) may be provided. Furthermore, the movable mold 62 may be configured to reciprocate linearly between the first fixed mold 61 and the second fixed mold 65, or three or more movable molds 62 may be configured to pass through positions facing the first fixed mold 61 and the second fixed mold 65, each of which is provided individually.

The second fixed mold 65 may be provided integrally and continuously with the first fixed mold 61, or may be configured as an individual mold independent of the first fixed mold 61. Namely, the first fixed mold 61 and the second fixed mold 65 may be configured in any mode as long as the first fixed mold 61 and the second fixed mold 65 can form different cavities with the movable mold 62, and may be an integrated mold or separate molds.

Next, the method for manufacturing the resin-molded article 10 (refer to FIG. 1) will be described.

Referring to FIG. 4, first, the first fixed mold 61, the movable mold 62, the slide mold 63, the film 15 to which the ink 15i is attached, the clamps 64 and 64, and the second fixed mold 65 (refer to FIG. 5) are prepared (preparation step).

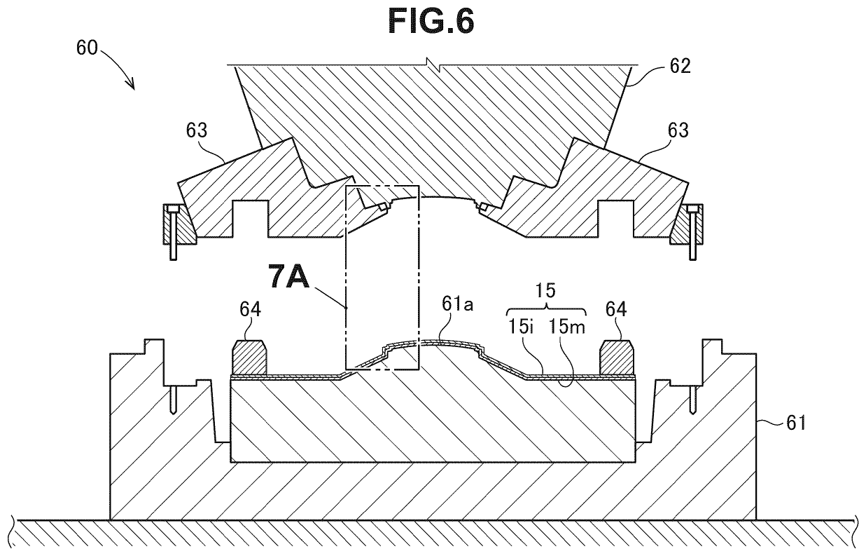

Referring to FIG. 6, next, the film 15 is placed on the placement portion 61a of the first fixed mold 61 with a surface of the film 15 facing upward, the ink 15i being attached to surface, and the film 15 is fixed using the clamps 64 and 64 (film fixing step).

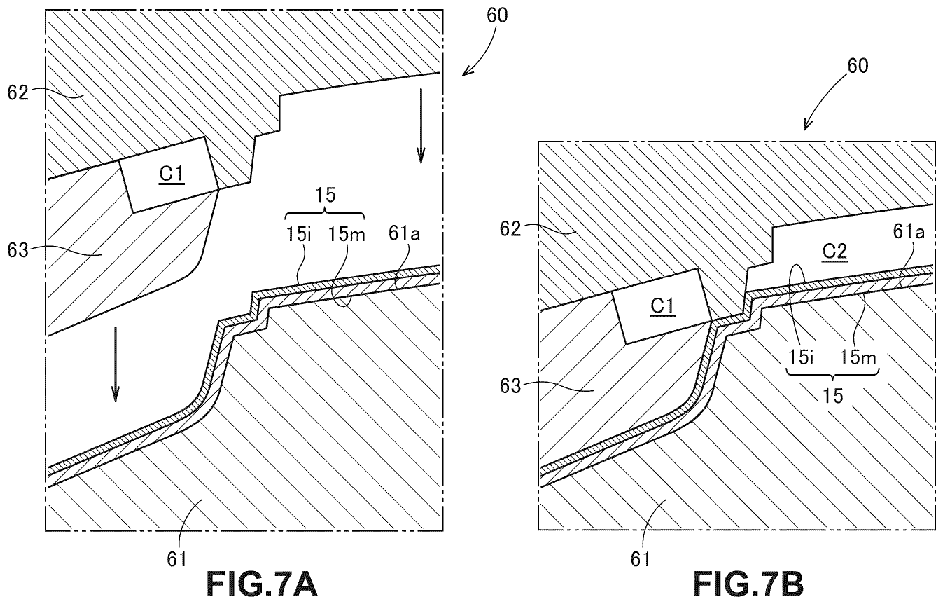

Referring to FIGS. 7A and 7B, the movable mold 62 is lowered, so that a second cavity C2 is formed by the first fixed mold 61 and the movable mold 62. In addition, the slide mold 63 is slid toward the movable mold 62 until the second cavity C2 is formed, and a first cavity C1 is formed by the movable mold 62 and the slide mold 63. The step of forming the first cavity C1 and the second cavity C2 is referred to as a first cavity forming step.

The first cavity C1 may be formed before the film fixing step (refer to FIG. 6). Meanwhile, the second cavity C2 should be formed by aligning the movable mold 62 to the first fixed mold 61 to which the film 15 is fixed.

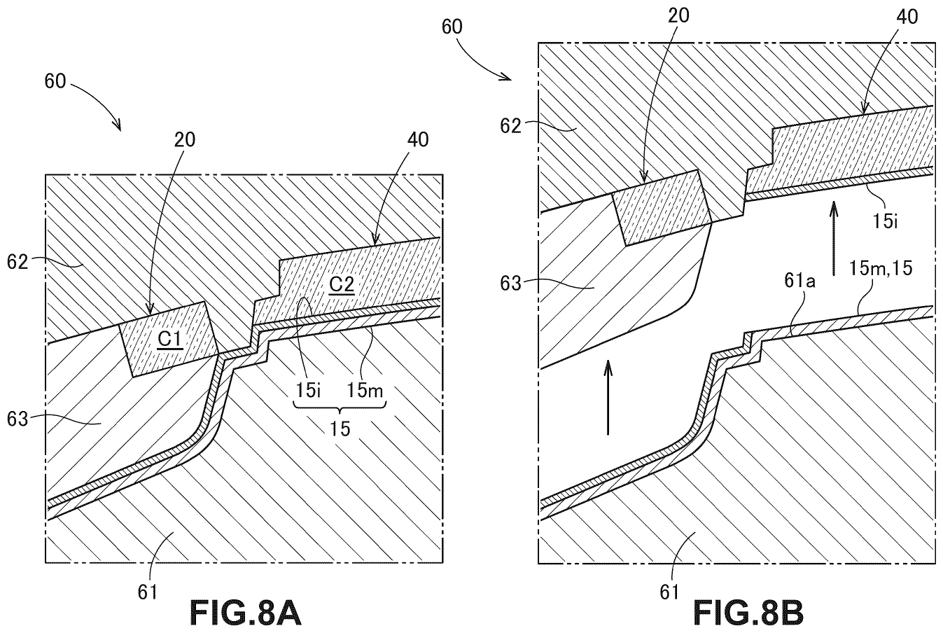

Referring to FIG. 8A, molten resin is injected into the first cavity C1 and the second cavity C2 (first resin injecting step), and the resin injected into the first cavity C1 and the second cavity C2 is cured (first resin curing step). The first resin components 20 and 30 and the second resin component 40 can be obtained by curing the injected resin.

Referring also to FIG. 3, in the first resin components 20 and 30, the first resin component body portions 22 and 32 are formed by the first cavity C1, and the first resin component extension portions 23 and 33 are formed by the second cavity C2. Meanwhile, the second resin component 40 is formed only by the second cavity C2.

Referring to FIG. 8B, once the resin is cured, the movable mold 62 is raised while the slide mold 63 is kept slid toward the movable mold 62 (movable mold and slide mold raising step). Since the ink 15i is transferred onto the second resin component 40, the ink 15i is separated from a rearing paper 15m, and is raised together with the movable mold 62.

Retractable pawls or the like (not illustrated) may be provided in the movable mold 62 to hold the second resin component 40.

Referring to FIG. 5, next, the movable mold 62 and the slide mold 63 are rotated (moved) to above the second fixed mold 65 (resin component moving step).

When two movable molds 62 and two slide molds 63 are provided, the other movable mold 62 and the other slide mold 63 move to above the first fixed mold 61 (refer to FIG. 4).

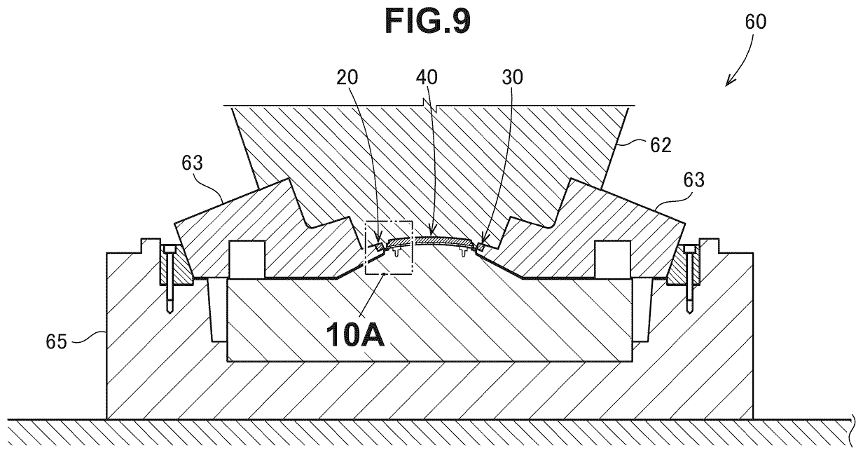

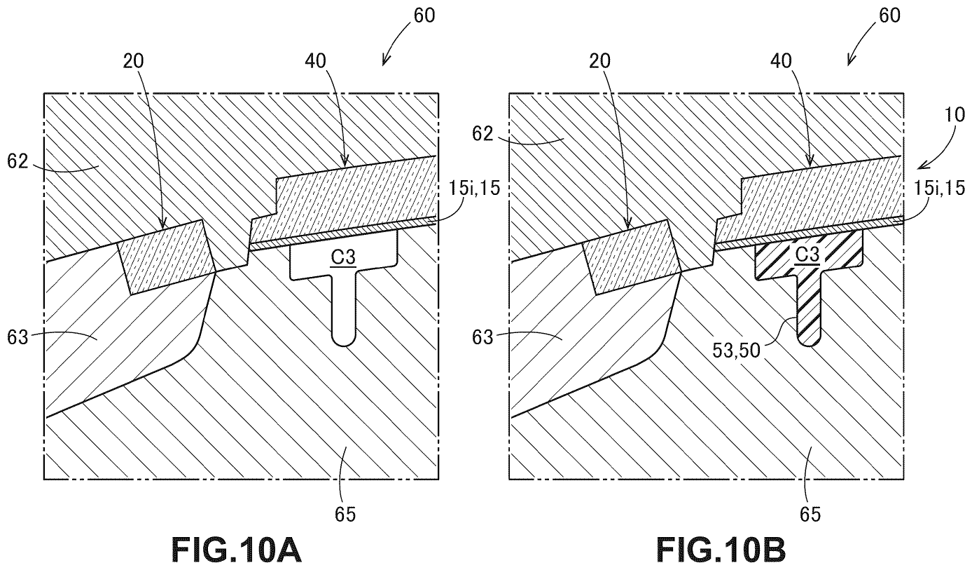

Referring to FIG. 9 and FIG. 10A, a third cavity C3 is formed by lowering the movable mold 62 and the slide mold 63 and aligning the movable mold 62 and the slide mold 63 with the second fixed mold 65 (second cavity forming step).

Referring to FIG. 10B, molten resin is injected into the third cavity C3 (second resin injecting step), and the resin injected into the third cavity C3 is cured (second resin curing step). The support component 50 can be obtained by the second resin curing step, and the resin-molded article 10 is completed.

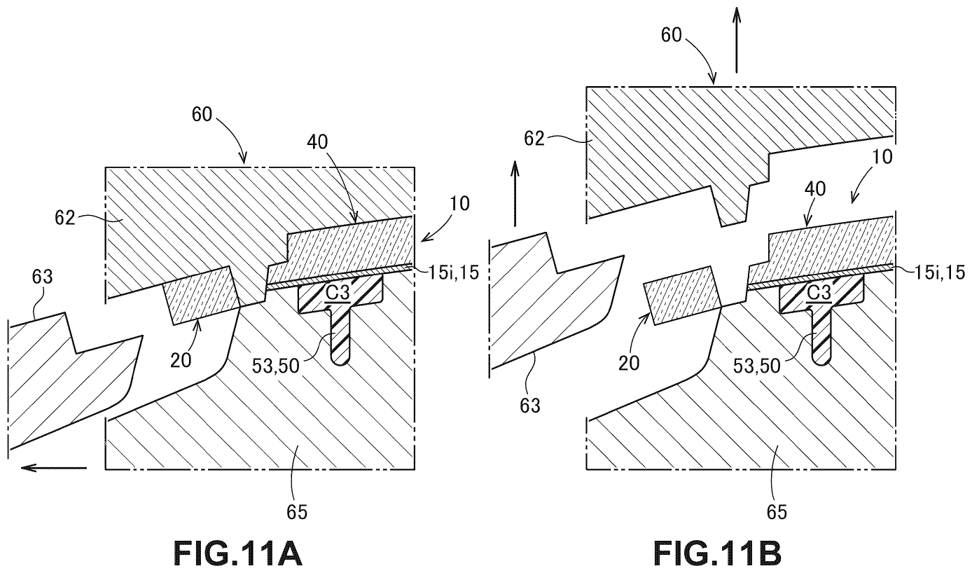

Referring to FIG. 11A, once the second resin curing step is ended, the slide mold 63 is retreated (slide mold retreat step), and as illustrated in FIG. 11B, the movable mold 62 and the slide mold 63 are raised (movable mold retreat step). Accordingly, the resin-molded article 10 can be removed from the second fixed mold 65.

The resin-molded article 10 may be moved to a specific location, and the slide mold 63 and the movable mold 62 may be retreated.

The technique for manufacturing the resin-molded article 10 described above will be summarized below.

Referring to FIG. 7A, in a first aspect, the method for manufacturing a resin-molded article includes the preparation step of preparing the first fixed mold 61 that is immovable, the movable mold 62 provided to be displaceable in the one direction (up-down direction) with respect to the first fixed mold 61, the slide mold 63 provided to be slidable in a direction different from the one direction with respect to the movable mold 62, and the film 15 to which the ink 15i to be transferred is attached; and the film fixing step of fixing the film 15 to the first fixed mold 61 such that the surface of the film 15 to which the ink 15i is attached faces the movable mold 62.

Referring to FIG. 7B, furthermore, the method for manufacturing a resin-molded article includes the first cavity forming step of forming the first cavity C1 using the movable mold 62 and the slide mold 63 by sliding the slide mold 63, and forming the second cavity C2 using the first fixed mold 61 and the movable mold 62 by aligning the movable mold 62 with the first fixed mold 61 to which the film 15 is fixed.

Referring to FIG. 8A, furthermore, the method for manufacturing a resin-molded article includes the first resin injecting step of injecting molten resin into the first cavity C1 and the second cavity C2; and the first resin curing step of obtaining the first resin component 20 cured in the first cavity C1 and the second resin component 40 cured in the second cavity C2 by curing the resin injected into the first cavity C1 and the second cavity C2.

Referring to FIG. 7B, in the first cavity forming step, the ink 15i faces only the second cavity C2.

The ink 15i faces only the second cavity C2, and the ink 15i does not face the first cavity C1. The ink 15i is not transferred onto the first resin component 20 (the first resin component body portions 22 and 32) formed in the first cavity C1, and the ink 15i is transferred only onto the portion formed by the second cavity C2. Therefore, the first resin component 20 including a portion onto which the ink 15i needs to be prevented from being transferred, and the second resin component 40 of which at least a part needs to be subjected to printing can be formed at the same time. The resin-molded article 10 (refer to FIG. 1) can be manufactured through a small number of steps.

Referring to FIG. 10B, in a second aspect, the method for manufacturing a resin-molded article according to the first aspect further includes preparing the second fixed mold 65 that is immovable and that is separate from the first fixed mold 61 (refer to FIG. 4), in the preparation step; the resin component moving step of moving the movable mold 62 and the slide mold 63 to a position facing the second fixed mold 65 while holding the first resin component 20 and the second resin component 40; the second cavity forming step of forming the third cavity C3 by aligning the movable mold 62, which is moved to the second fixed mold 65, with the second fixed mold 65; the second resin injecting step of injecting the molten resin into the third cavity C3; and the second resin curing step of obtaining the support component 50, which supports the first resin component 20 and the second resin component 40, by curing the resin injected into the third cavity C3.

Since the first resin component 20 and the second resin component 40 can be formed at the same time, the first resin component 20 and the second resin component 40 can be moved together to the second fixed mold 65, and can be supported and connected by the support component 50. The resin-molded article 10 (refer to FIG. 1) can be manufactured through a smaller number of steps compared to when the first resin component 20 and the second resin component 40 are separately moved to the second fixed mold 65 and the support component 50 is formed.

Referring to FIG. 7B, in a third aspect, the mold 60 includes the first fixed mold 61 that is immovable; the movable mold 62 provided to be displaceable in the one direction with respect to the first fixed mold 61; and the slide mold 63 provided to be slidable in a direction different from the one direction with respect to the movable mold 62. The first fixed mold 61 includes the placement portion 61a on which the film 15 to which the ink 15i is attached is placed. Resin is allowed to be injected between the movable mold 62 and the slide mold 63 by sliding the slide mold 63, and the first cavity C1 that becomes the first resin component 20 (refer to FIG. 8A) by curing the injected resin is formed. The resin is allowed to be injected into a portion, which the placement portion 61a faces, by aligning the movable mold 62 with the first fixed mold 61, and the second cavity C2 that becomes the second resin component 40 by curing the injected resin is formed.

The ink 15i can be made to face only the second cavity C2, and the ink 15i does not face the first cavity C1. The ink 15i is not transferred onto the first resin component 20 (the first resin component body portions 22 and 32 and refer to FIG. 8A) formed in the first cavity C1, and the ink 15i is transferred only onto the portion formed by the second cavity C2. Therefore, the first resin component 20 including a portion onto which the ink 15i needs to be prevented from being transferred, and the second resin component 40 (refer to FIG. 8A) of which at least a part needs to be subjected to printing can be formed at the same time. The resin-molded article 10 (refer to FIG. 1) can be manufactured through a small number of steps by using the mold 60.

Referring to FIG. 10A, in a fourth aspect, the mold 60 according to the third aspect further includes the second fixed mold 65 that is immovable and that is separate from the first fixed mold 61 (refer to FIG. 7B). The resin is allowed to be injected by aligning the movable mold 62, in which the first resin component 20 and the second resin component 40 are formed, with the second fixed mold 65, and the third cavity C3 that becomes the support component 50 that supports the first resin component 20 and the second resin component 40 by curing the injected resin is formed.

Since the first resin component 20 and the second resin component 40 can be formed at the same time, the first resin component 20 and the second resin component 40 can be moved together to the second fixed mold 65, and can be supported and connected by the support component 50. The resin-molded article 10 (refer to FIG. 1) can be manufactured through a smaller number of steps compared to when the first resin component 20 and the second resin component 40 are separately moved to the second fixed mold 65 and the support component 50 is formed. The resin-molded article 10 (refer to FIG. 1) can be manufactured through a small number of steps by using the mold 60.

Referring to FIG. 2, in a fifth aspect, the resin-molded article 10 includes the first resin component 20 that is a resin component; the second resin component 40 that is a resin component provided spaced apart from the first resin component 20; and the support component 50 that integrally supports the first resin component 20 and the second resin component 40. When the surface of the first resin component 20 facing the support component 50 is defined as the first support surface 21, and the surface of the second resin component 40 facing the support component 50 is defined as the second support surface 43, at at least a part of the first support surface 21, resin constituting the first resin component 20 is exposed to the outside, and at least a part of the second support surface 43 is subjected to printing.

By exposing the resin constituting the first resin component 20 to the outside at at least part of the first support surface 21, the absorption of light, which is reflected inside the first resin component 20, by the ink 15i can be suppressed, and the product is allowed to illuminate up to a location farther from the light source. In addition, the entirety of the second support surface 43 is subjected to printing. If the first resin component 20 and the second resin component 40 are individually formed and attached to the support component 50, and then printing is performed, printing cannot be performed on the entirety of the second support surface 43. Since the resin-molded article 10 is such that the first resin component 20 and the second resin component 40 are molded at the same time and the support component 50 is integrally configured, the entirety of the second support surface 43 can be subjected to printing. According to the resin-molded article 10 manufactured in such a manner, the resin-molded article 10 can be manufactured through a small number of steps.

The technique for manufacturing a resin-molded article according to the invention has been described using an example of a component used in a dashboard of a vehicle; however, the technique can also be applied to other portions in a passenger compartment or resin-molded articles for non-vehicle applications, and is not limited to these forms. Namely, the invention is not limited to the embodiment as long as actions and effects of the invention are achieved.

What is claimed is:

1. A method for manufacturing a resin-molded article, the method comprising:
a preparation step of preparing a first fixed mold that is immovable, a movable mold provided to be displaceable in one direction with respect to the first fixed mold, a slide mold provided to be slidable in a direction different from the one direction with respect to the movable mold, and a film to which ink to be transferred is attached;
a film fixing step of fixing the film to the first fixed mold such that a surface of the film to which the ink is attached faces the movable mold;
a first cavity forming step of forming a first cavity using the movable mold and the slide mold by sliding the slide mold, and forming a second cavity using the first fixed mold and the movable mold by aligning the movable mold with the first fixed mold to which the film is fixed;
a first resin injecting step of injecting molten resin into the first cavity and the second cavity; and
a first resin curing step of obtaining a first resin component cured in the first cavity and a second resin component cured in the second cavity by curing the resin injected into the first cavity and the second cavity.
wherein in the first cavity forming step, the ink faces only the second cavity.

2. The method for manufacturing a resin-molded article according to claim 1, further comprising:
preparing a second fixed mold that is immovable and that is separate from the first fixed mold, in the preparation step;
a resin component moving step of moving the movable mold and the slide mold to a position facing the second fixed mold while holding the first resin component and the second resin component;
a second cavity forming step of forming a third cavity by aligning the movable mold, which is moved to the second fixed mold, with the second fixed mold;
a second resin injecting step of injecting the molten resin into the third cavity; and
a second resin curing step of obtaining a support component, which supports the first resin component and the second resin component, by curing the resin injected into the third cavity.

3. A mold comprising:
a first fixed mold that is immovable;
a movable mold provided to be displaceable in one direction with respect to the first fixed mold; and
a slide mold provided to be slidable in a direction different from the one direction with respect to the movable mold,
wherein the first fixed mold includes a placement portion on which a film to which ink is attached is placed,
resin is allowed to be injected between the movable mold and the slide mold by sliding the slide mold, and a first cavity that becomes a first resin component by curing the injected resin is formed, and
the resin is allowed to be injected into a portion, which the placement portion faces, by aligning the movable mold with the first fixed mold, and a second cavity that becomes a second resin component by curing the injected resin is formed.

4. The mold according to claim 3, further comprising:
a second fixed mold that is immovable and that is separate from the first fixed mold,
wherein the resin is allowed to be injected by aligning the movable mold, in which the first resin component and the second resin component are formed, with the second fixed mold, and a third cavity that becomes a support component that supports the first resin component and the second resin component by curing the injected resin is formed.

5. The mold according to claim 3,
wherein in a state where the first cavity and the second cavity are formed, the ink faces only the second cavity.

6. A resin-molded article comprising:
a first resin component that is a resin component;
a second resin component that is a resin component provided spaced apart from the first resin component; and
a support component that integrally supports the first resin component and the second resin component,
wherein when a surface of the first resin component facing the support component is defined as a first support surface, and a surface of the second resin component facing the support component is defined as a second support surface, at at least a part of the first support surface, resin constituting the first resin component is exposed to an outside, and at least a part of the second support surface is subjected to printing.
